(19) United States
(12) Patent Application Publication
(10) Pub. No.: US 2025/0087954 A1
(43) Pub. Date: Mar. 13, 2025

(54) SHAFT CURRENT COLLECTOR AND SHAFT ASSEMBLY

(71) Applicant: Trelleborg Sealing Solutions Germany GmbH, Stuttgart (DE)

(72) Inventors: Martin Franz, Wannweil (DE); Maike Khosrawi, Stuttgart (DE); Johan Strandberg, Stuttgart (DE)

(73) Assignee: Trelleborg Sealing Solutions Germany GmbH, Stuttgart (DE)

(21) Appl. No.: 18/960,235

(22) Filed: Nov. 26, 2024

Related U.S. Application Data
(63) Continuation of application No. PCT/EP2023/058104, filed on Mar. 29, 2023.

(30) Foreign Application Priority Data
May 30, 2022 (DE) 10 2022 205 412.1

(51) Int. Cl. H01R 39/12

(52) U.S. Cl. CPC H01R 39/12

(57) ABSTRACT

A shaft current collector for a shaft assembly has a shaft and a machine part surrounding the shaft. The shaft current collector has an electrically conductive ring for arrangement on the shaft so as to electrically contact the same. The ring has an engagement recess which is arranged so as to extend axially relative to the central axis of the ring. A blocking element can be secured on the machine part relative to the shaft. When the shaft current collector is in the installed state, the blocking element engages into the engagement recess of the ring such that, as the shaft rotates, a rotation of the ring is restricted by the blocking element while the ring is electrically conductively contacted by the blocking element. A shaft assembly may have such a shaft current collector.

### CROSS-REFERENCE TO RELATED APPLICATIONS

This continuation application claims priority to PCT/EP2023/058104 filed on Mar. 29, 2023 which has published as WO 2023/232313 A1 and also the German application number DE 10 2022 205 412.1 filed on May 30, 2022, the entire contents of which are fully incorporated herein with these references.

### DESCRIPTION

### Field of the Invention

The present invention relates to a shaft current collector and to a shaft assembly comprising same.

### Background of the Invention

In shaft assemblies, such as generators and electric motors, undesired destructive electrical currents can occur during routine operation, which currents can damage bearing components and possibly sealing elements that are installed for the purposes of sealing the components that are movable relative to one another. For example, shaft voltages and shaft currents on a motor shaft can be induced simply owing to non-uniform air gap magnetic flux transitions in the motor. In other words: The difference between the individual poles of a motor (although these are ideally identical) leads to the formation of an induced current in the motor shaft. Furthermore, the use of drives of variable rotational speed and of the associated controllers (for example of pulse width modulation type) also lead to abrupt current transitions and associated magnetic flux transitions, which give rise to an undesired induced current in the motor shaft. In practice, it is therefore sought to dissipate such induced currents and voltages without jeopardizing the operation of the motor or the integrity of its components. The established method for dissipating, in particular, induced, shaft currents are based on an electrical dissipation path in the case of which the shaft currents are dissipated from the shaft with as low an electrical resistance as possible, that is to say in low-ohmic fashion. The currents must not be conducted via the aforementioned bearing components, in order that these do not sustain damage.

DE 10 2018 117 315 A1 discloses, for example, a rolling bearing in which an electrical collector element in the form of a sliding contact element is arranged between two bearing rings, which sliding contact element serves to dissipate the aforementioned parasitic currents. The sliding contact element is disk-shaped, is fastened rotationally conjointly to a first bearing ring, and consists of an electrically conductive material. The sliding contact element makes electrically conductive sliding contact with a second bearing ring. The sliding contact element may for example comprise so-called nanotubes as electrical conductors.

By contrast, US 2002/0121821 A1 discloses a shaft assembly in which shaft currents are dissipated from the shaft, into a shaft housing surrounding the shaft, via an electrically conductive lubricant. There is the risk here that, as the shaft rotates, the lubricant moves away from the dedicated shaft current dissipation region under the action of centrifugal force, with the result that electrical contacting between the components that are movable relative to one another is no longer possible. Also, at high shaft rotational speeds, the electrically conductive lubricant can heat up and lose its function as an electrical conductor.

JP 2000266067 A discloses a shaft assembly in which the undesired shaft

currents are achieved by means of electrically conductive contact of a shaft current collector with the machine parts that are movable relative to one another. Here, the shaft current collector is of wire form at one end.

U.S. Pat. No. 1,735,579 B in turn proposes a shaft current collector which comprises a plurality of wedge-shaped metal tongues which are arranged around the shaft in the circumferential direction and which are jointly pressed against the hub of the shaft by means of an elastic preloading strap. The metal tongues make electrically conductive contact, under the action of centrifugal force, with a bevel of the housing.

It is to be noted that any shaft-current collector whose function is based on dynamic electrical contacting of one of the electrically conductive components is subject to considerable mechanical wear. In this respect, there is the risk of generally premature functional failure here, similarly to the case of brushes in electric motors. The electrical contacting can also be impeded, or even prevented, by liquid or pasty lubricants that are typically used.

It is therefore the object of the invention to specify a shaft current collector and a shaft assembly which overcome the disadvantages of the prior art and which can be provided inexpensively and with low technical complexity.

### SUMMARY OF THE INVENTION

The object relating to the shaft current collector is achieved by means of a shaft current collector as claimed in claim 1. The shaft assembly according to the invention has the features specified in claim 11. Preferred refinements of the invention are specified in the subclaims and in the description.

The shaft current collector according to the invention is provided for use in a shaft assembly with a shaft and with a machine part surrounding the shaft, and comprises: an electrically conductive ring for arrangement on the shaft so as to electrically contact same, which ring has an engagement recess which is arranged so as to extend axially relative to the central axis; and an electrically conductive blocking element which can be secured on the machine part relative to the shaft and which, when the shaft current collector is in the installed state, engages into the engagement recess of the ring such that, as the shaft rotates, a rotation of the ring is restricted by the blocking element whilst the ring is electrically conductively contacted by the blocking element.

During operational use, the shaft current collector according to the invention makes it possible for shaft currents to be reliably discharged into the machine part surrounding the shaft. According to the invention, the electrically conductive ring may consist entirely of an electrically conductive material or else may comprise an electrically conductive material. The electrically conductive material may, in particular, be metal or an electrically conductive polymer material, in particular, a polymer doped with metal or carbon.

In one refinement of the invention, the ring is of fully slotted form. A fully slotted ring is firstly easier to install on a shaft, and also has a further crucial advantage: If the ring, in its installed state on the shaft, is prevented from rotating conjointly with the shaft by the blocking element, then the ring can, if it is in frictional engagement with the shaft and if a free end of the ring is supported on the blocking element, expand (to a minimal extent) such that the ring and the shaft can more easily transition into a state of sliding friction relative to one another whilst maintaining electrically conductive contact with one another.

In one embodiment of the invention, the ring has a main body, from the outer circumference of which at least one rib extends, which rib defines the engagement recess. The rib may for example be arranged in the central plane of the ring.

Here, the aforementioned rib may have two end portions which are spaced from one another in the circumferential direction of the ring so as to form the engagement recess. The engagement recess is thus open in a radial direction, thus making the installation of the shaft current collector altogether easier.

According to the invention, the ring may, in particular, be formed as a spring ring. Here, the spring is preferably rubber-elastically expandable. In this way, when the spring ring is in the installed state, particularly reliable electrically conductive contacting of the shaft by the ring can be ensured at all times. Manufacturing tolerances of the spring ring and of the shaft can be compensated in a simple manner. Also, in this way, it can be made even easier for the ring to be installed as intended on the shaft.

In a particularly preferred refinement, the blocking element can be latched in the engagement recess of the ring. In this way, the installation of the shaft current collector can be simplified, and the ring and the blocking element can be reliably held in a specified relative position. The blocking element may for example have a mushroom head that can be latched in an engagement opening, which is of complementary design with respect to said mushroom head, of the ring.

According to the invention, the blocking element may have a trapezoidal cross-sectional shape having side flanks which converge in an outward radial direction with respect to the central axis Z. If the ring has end faces which correspond/are complementary with respect to the side flanks and which converge relative to one another in an outward radial direction, an expansion of the ring by the blocking element during operational use can thus be made even easier.

In one embodiment of the invention, the electrically conductive ring may also consist of individual segments which are arranged one behind the other in the circumferential direction of the shaft. When the shaft current collector is in the installed state, these individual segments may be arranged in the (sealing) gap between the shaft and machine part and engage into a holding groove of the machine part, or may be secured or fixed in position in the axial direction relative to the blocking element or relative to the shaft by a securing ring.

In one embodiment according to the invention, the electrically conductive ring may be equipped with a rubber-elastically deformable preloading ring in the form of a spring or an elastomer ring, by means of which the ring is pressed in a radial direction against the shaft.

According to the invention, the electrically conductive ring may furthermore, on its contact side facing toward the shaft, have profile structures or tribological structures for discharging lubricant from the contact gap. The tribological structures may, in particular, be in the form of ribs or may be triangular or wing-shaped.

The shaft assembly according to the invention comprises a shaft and a machine part surrounding the shaft, which shaft and machine part are spaced from one another so as to form a sealing or bearing gap and are movable relative to one another about an axis of rotation. The shaft assembly has a shaft current collector as discussed above. The electrically conductive ring is mounted on the shaft, and the electrically conductive blocking element is secured (so as to be static) on the machine part such that, as the shaft rotates, a rotation of the ring is restricted by the blocking element whilst the ring is electrically conductively contacted by the blocking element. It is self-evident that the shaft consists of metal or of some other, preferably electrically conductive, material.

The ring is preferably designed as a slotted spring ring, wherein a rotation of the shaft whilst the ring is supported on the blocking element causes an expansion of the spring ring supported on the blocking element. The ring can thus make electrically conductive contact with the shaft with particularly low friction.

The invention will be discussed in more detail below on the basis of exemplary embodiments illustrated in the drawing. The exemplary embodiments shown are purely exemplary and are not to be understood as limiting the invention.

### BRIEF DESCRIPTION OF THE DRAWINGS

In the drawings:

FIG. 1 shows a shaft assembly with a shaft and with a machine part surrounding the shaft, with a sealing unit, with a bearing, and with a shaft current collector which has an electrically conductive ring and an associated blocking element and via which capacitive and/or inductive currents can be dissipated from the shaft into the machine part;

FIG. 2 shows the electrically conductive ring according to FIG. 1, viewed in isolation;

FIG. 3 shows a further embodiment of the ring of a shaft current collector according to FIG. 1, in a perspective view in isolation;

FIG. 4 shows a further embodiment of the shaft current collector, in which the blocking element and the electrically conductive ring can be latched together, in a detail illustration;

FIG. 5 shows a further embodiment of the shaft current collector, in which the blocking element has, at least in part, a trapezoidal basic shape and engages into a corresponding engagement recess of the ring, in a plan view;

FIG. 6 show a further embodiment of the shaft current collector in a perspective view in isolation (FIG. 6A) and in a side view (FIG. 6B), in which embodiment the blocking element has a trapezoidal cross-sectional shape, and in which embodiment the engagement recess is delimited by radially outwardly converging end faces, such that the blocking element is confined in a purely radial outward direction in the engagement recess;

FIG. 7 shows an electrically conductive ring for the shaft current collector according to FIG. 1, which is equipped on the inner circumference with a plurality of spiral-shaped tribological structures, in a perspective view in isolation; and

FIG. 8 shows a further embodiment of an electrically conductive ring for the shaft current collector according to FIG. 1, which is equipped on the inner circumference with wing-like tribological structures, in a perspective view in isolation.

### DETAILED DESCRIPTION OF EMBODIMENTS OF THE INVENTION

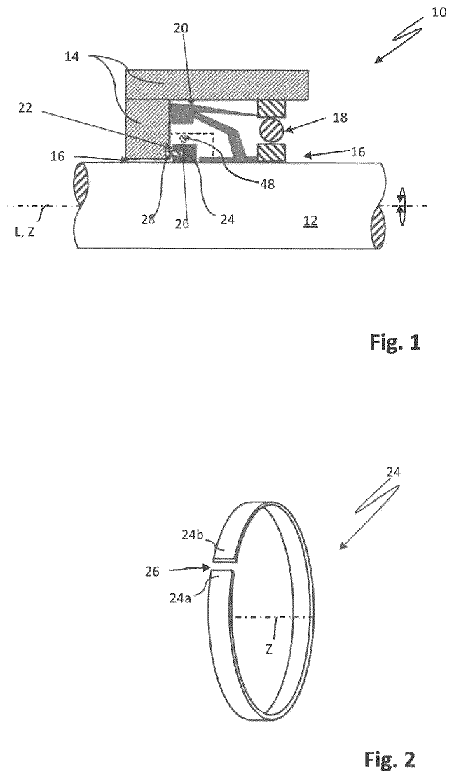

FIG. 1 shows a shaft assembly 10 comprising a shaft 12 and comprising a machine part 14, for example a shaft housing, surrounding the shaft 12, in a detail sectional illustration.

The shaft 12 and the machine part 14 are spaced from one another, forming a sealing or bearing gap 16, and are mounted so as to be movable relative to one another, about an axis of rotation denoted by L, by means of a plurality of bearings 18. For the purposes of the illustration, only one of the bearings 18 is shown in FIG. 1. One or more seal elements 20 are used to dynamically seal the sealing or bearing gap 16, which seal elements may each be designed as a radial or axial seal element.

A shaft current collector, denoted as a whole by 22, is used to dissipate inductive or capacitive currents, which are potentially damaging to the bearings 18 and seal elements 20, from the shaft 12. The shaft current collector 22 comprises an electrically conductive ring 24 that is arranged on the shaft 12 for the purposes of electrically contacting the shaft 12. The ring 24 is arranged on the shaft with an interlocking sliding fit. The ring 24 has at least one engagement recess 26 that extends axially with respect to the central axis Z of the ring 24.

The shaft current collector 22 furthermore comprises an electrically conductive blocking element 28. The blocking element 28 is fastened to the machine part 14. This may be achieved by virtue of the blocking element 28 being screwed, soldered or welded to the machine part 14, or by some other suitable—electrically conductive—means.

In the illustrated installed state of the shaft current collector 22, the blocking element 28 engages into the engagement recess 26 of the ring 24 such that, as the shaft 12 rotates, a rotation of the ring 24 is restricted by the blocking element 28. Here, the ring 24 makes electrically conductive contact with both the shaft 12 and the blocking element 28.

In principle, the ring 24 may consist entirely of an electrically conductive material or else may comprise at least an electrically conductive material. In the latter case, it is thus possible for only a part or a portion of the ring 24 to consist of an electrically conductive material. As an electrically conductive material of the ring 24, use may for example be made of metal or an electrically conductive polymer material, in particular, a polymer doped with metal or carbon.

FIG. 2 shows the ring 24 according to FIG. 1 in a perspective view in isolation. The ring 24 is altogether of slotted form and thus has, in the circumferential direction, two end portions 24a, 24b that point toward one another. Said end portions 24a, 24b delimit the engagement recess 26 in the circumferential direction of the ring 24. The ring 24 is in this case designed as a spring ring, that is, to say may exhibit rubber-elastic or tough elastic deformability. The ring 24 can thus be installed more easily on the shaft 12. If the ring 24 is designed as a spring ring, manufacturing tolerances of the ring 24 and of the shaft 12 can thus be reliably compensated.

In the case of a slotted ring 24, it is possible during operational use to achieve particularly low friction between the shaft 12 and the ring 24, whilst at the same time maintaining electrically conductive contacting of the shaft 12 by the ring 24.

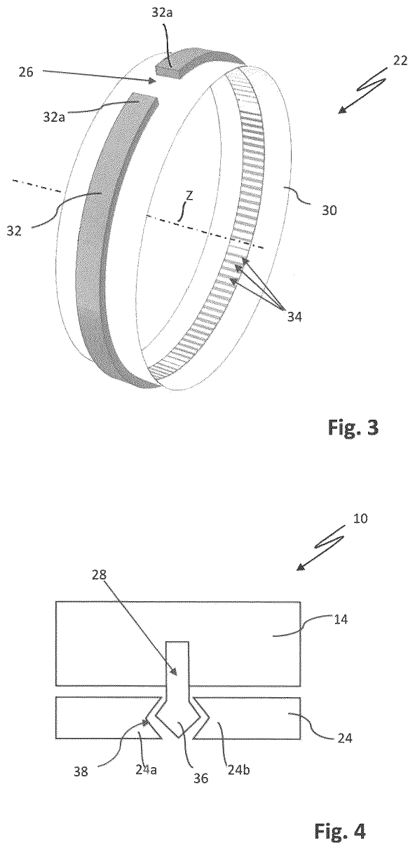

In the exemplary embodiment shown FIG. 3, the ring 24 may have a main body 30, from the outer circumference of which at least one profile element 32, in this case in the form of a rib or a web, extends. Here, said profile element 32 defines the axially extending engagement recess 26 for the blocking element 28. At the inside in the radial direction, the engagement recess is delimited at least in part, or entirely, as shown in FIG. 3, by the main body. The profile element 32 has two end portions 32a, 32b which are spaced from one another in the circumferential direction of the ring 24 so as to form the engagement recess 26. In an embodiment that is not shown in any more detail in the drawing, the engagement recess 26 may also be formed as an (axial) through bore or as a radial indentation (=depression) in the ring 24 or in the profile element 32.

Here, the profile element 32 shown in FIG. 3 comprises, or is formed from, an electrically conductive metal. By contrast, if the main body 30 of the ring 24 consists of an insulator, for example an electrically non-conductive plastics polymer, then the main body 30 preferably has a plurality of radial apertures 34 which are spaced from one another in the circumferential direction of the ring 24. The material of the profile projection 32 may extend, in a radial direction with respect to the central axis Z, inward through the radial apertures 34 of the main body 30 towards the central axis Z in order to thus ensure direct electrically conductive contacting of the shaft 12. Here, the main body 30 allows the ring 24 to be supported on the shaft 12 over a broad area and so as to be secured against tilting. The main body may be of closed ring-shaped form, as per FIG. 3, or may itself be of slotted form. If the main body is formed from an elastically deformable polymer material, then the ring as a whole may be formed as an elastically expandable spring ring.

The blocking element 28 illustrated in the drawing may in principle consist of metal or of an electrically conductive polymer, or may comprise one of these materials.

In the exemplary embodiment shown in FIG. 4, the blocking element 28 may be latchable, preferably by way of its free end portion 36, in the engagement recess 26 of the ring 24. In this way, when the shaft current collector 22 is in the installed state, the ring 24 can be easily and reliably secured in its specified axial (and rotational) functional position on the shaft 12 relative to the blocking element 28. The latching connection 38 between the blocking element 28 and the ring 24 may in this case exhibit or allow both axial and radial play between the blocking element 28 and the ring 24.

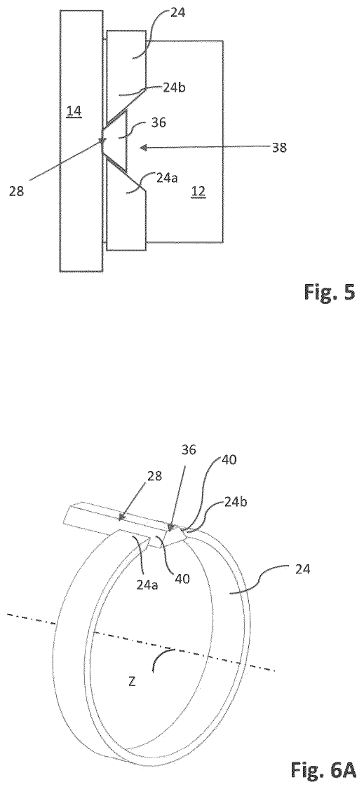

FIG. 5 shows a further shaft current collector 22. Here, the blocking element 28 has, at least in part, a trapezoidal basic shape, that is, to say a free end portion 36 which widens in the distal direction. The engagement recess 26 of the electrically conductive ring 24 is correspondingly shaped such that the blocking element is latchable, or held by latching action, in the engagement recess 26.

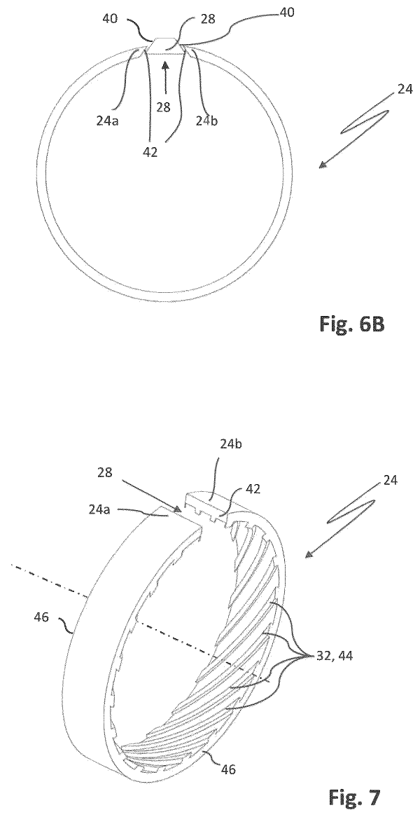

FIGS. 6A and 6B show a further shaft current collector 22 in a perspective view in isolation. Here, the blocking element 28 is of pin-like or web-like form with a trapezoidal cross-sectional shape. The blocking element 28 tapers in an outward radial direction with respect to the central axis Z of the electrically conductive ring 24. Side flanks 40 of the blocking element 28 thus converge in an outward radial direction. The free end portions 24a, 24b of the ring 24 have end faces 42 which correspond to, or are shaped complementarily with respect to, said side flanks and which converge relative to one another in an outward radial direction. During operational use of the shaft current collector 22, the ring 24 can thus be more easily expanded, by abutment of a side flank 40 of the blocking element 28 against one of the end faces 42 of the ring 24. The frictional resistance between the ring 24 and the shaft 12 (FIG. 1) can thus be particularly reliably reduced. This is the case irrespective of the direction of rotation of the shaft 12 about the axis of rotation L (FIG. 1).

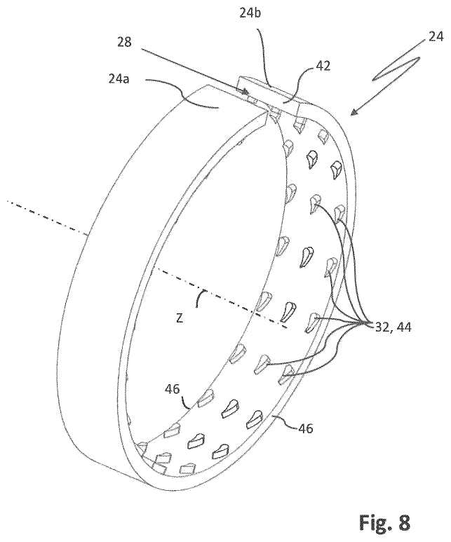

In the exemplary embodiments of the electrically conductive ring 24 of a shaft current collector according to the invention shown in FIGS. 7 and 8, said ring may, on the inner circumference, have profile projections 32 in the form of tribological structures 44. By means of such tribological structures 44, lubricant that has entered the sealing or bearing gap 16 (FIG. 1) between the ring 24 and the shaft 12 (FIG. 1) can, during the operational use of the shaft current collector 22, be at least partially moved, in an axial direction with respect to the axis of rotation L, out of the region of contact between the ring 24 and the shaft 12. In the embodiment according to FIG. 7, the tribological structures 44 each extend helically in an axial direction from one edge 46 of the ring 24 to the other, and are arranged one behind the other, and spaced from one another in the circumferential direction of the ring 24. The tribological structures 44 may also, as per FIG. 8, be designed as triangular or wing profiles. In the latter case, a plurality of tribological structures 44 may be arranged one behind the other, or else so as to be offset with respect to one another, for example in each case “in gaps”, in the direction of the central axis Z. Other suitable profiles for the tribological structures 44 are entirely conceivable to a person skilled in the art.

Altogether, the tribological structures, even when exposed to lubricant, allow electrical contacting of the shaft 12 by the ring 24 with particularly low resistance. In other words, the electrical contact resistance between the shaft 12 and the ring 24 can be minimized.

The shaft current collector 10 may additionally have a clamping ring 48 by means of which the ring 24 is pressed in a radial direction against the shaft 12, as illustrated by a dashed line in FIG. 1.

In summary, the invention relates to a shaft current collector 22 for a shaft assembly 10 comprising a shaft 12 and comprising a machine part 14 surrounding the shaft 12. The shaft current collector 22 comprises an electrically conductive ring 24 for arrangement on the shaft 12 so as to electrically contact same, which ring has an engagement recess 26 which is arranged so as to extend axially relative to the central axis Z of the ring 24. A blocking element 28 can be secured on the machine part 14 relative to the shaft 12 and, when the shaft current collector 22 is in the installed state, engages into the engagement recess 26 of the ring 24 such that, as the shaft 12 rotates, a rotation of the ring 24 is restricted by the blocking element 28 whilst the ring 24 is electrically conductively contacted by the blocking element 28. The invention also relates to a shaft assembly 10 having such a shaft current collector 22.

What is claimed is:

1. A shaft current collector for a shaft assembly comprises a shaft and a machine part surrounding the shaft, the shaft current collector comprising:
an electrically conductive ring for arrangement on the shaft configured to electrically contact the shaft, wherein the ring has an engagement recess configured to extend axially relative to the central axis of the ring;
a blocking element configured to be secured on the machine part relative to the shaft and wherein the blocking element, when the shaft current collector is in the installed state, engages into the engagement recess of the ring, wherein, as the shaft rotates, a rotation of the ring is restricted by the blocking element while the ring is electrically conductively contacted by the blocking element;
wherein the ring is of fully slotted form and is formed as an elastically expandable spring ring, or wherein the ring consists of individual segments arranged one behind the other in the circumferential direction of the shaft.

2. The shaft current collector as claimed in claim 1, wherein the ring consists entirely of an electrically conductive material or comprises an electrically conductive material.

3. The shaft current collector as claimed in claim 2, wherein the ring has a main body, from the outer circumference of which at least one profile projection extends, which profile projection defines the engagement recess.

4. The shaft current collector as claimed in claim 3, wherein the profile projection has two end portions which are spaced from one another in the circumferential direction of the ring forming the engagement recess.

5. The shaft current collector as claimed in claim 3, wherein the main body has a plurality of radial apertures through which the profile projection extends radially in the direction of the central axis.

6. The shaft current collector as claimed in claim 1, wherein the blocking element is configured to be latched in the engagement recess of the ring.

7. The shaft current collector as claimed in claim 1, wherein the blocking element has a trapezoidal cross-sectional shape having side flanks which converge in an outward radial direction with respect to the central axis, and wherein the ring has end faces which correspond to the side flanks and which converge in an outward radial direction.

8. The shaft current collector as claimed in claim 1, wherein the electrically conductive ring has tribological structures on the inner circumference.

9. The shaft current collector as claimed in claim 1, wherein the conductive material of the ring is metal or is an electrically conductive polymer material.

10. A shaft assembly comprising a shaft and a machine part surrounding the shaft, wherein the shaft and the machine part are spaced from one another so as to form a sealing or bearing gap and are movable relative to one another about an axis of rotation, wherein the shaft assembly comprises a shaft current collector, the shaft current collector comprising:
an electrically conductive ring for arrangement on the shaft configured to electrically contact the shaft, wherein the ring has an engagement recess which is arranged to extend axially relative to the central axis of the ring;
a blocking element which can be secured on the machine part relative to the shaft and which, when the shaft current collector is in the installed state, engages into the engagement recess of the ring wherein, as the shaft rotates, a rotation of the ring is restricted by the blocking element while the ring is electrically conductively contacted by the blocking element;
wherein the electrically conductive ring of the shaft current collector is mounted on the shaft, and the electrically conductive blocking element is fastened to the machine part, wherein, as the shaft rotates, a rotation of the ring relative to the machine part is restricted by the blocking element while the ring is electrically conductively contacted by the blocking element.

11. The shaft assembly as claimed in claim 10, wherein the ring is formed as a fully slotted, spring ring, and a rotation of the shaft about the axis of rotation causes an expansion of the spring ring, which is supported in the circumferential direction on the blocking element.

12. The shaft assembly as claimed in claim 10, wherein the ring is preloaded in a radial direction against the shaft by a preloading ring.
